(19) United States
(12) Patent Application Publication
(10) Pub. No.: US 2013/0085822 A1
(43) Pub. Date: Apr. 4, 2013

(54) Mutually Advertising System, Advertisement Distribution Planning Apparatus and Method, and Computer Program

(71) Applicant: Tomohiro Azami, Yokohama-shi (JP)

(72) Inventor: Tomohiro Azami, Yokohama-shi (JP)

(73) Assignee: JVC KENWOOD CORPORATION, Kanagawa (JP)

(21) Appl. No.: 13/611,088

(22) Filed: Sep. 12, 2012

(30) Foreign Application Priority Data
Sep. 30, 2011 (JP) 2011-218411

(51) Int. Cl. G06Q 30/02

(52) U.S. Cl. 705/14.4

(57) ABSTRACT

A mutually advertising system includes an ad distribution planning apparatus and ad indication systems. Each ad indication system includes a digital signage for indicating ads, and a section for calculating viewing indexes with respect to the respective indicated ads and for sending the calculated viewing indexes to the ad distribution planning apparatus. The ad distribution planning apparatus includes a section for, with respect to each ad indication system, identifying advertisers of the respective ads among business enterprises, for calculating evaluation values of the viewing indexes sent from the ad indication systems and regarding each of the identified advertisers, and for calculating degrees of relations between the business enterprises from the calculated evaluation values. The ad distribution planning apparatus further comprises a section for setting distribution allotment degrees for each of ads to be distributed to the ad indication systems in accordance with the calculated relations degrees.

### CROSS-REFERENCE TO RELATED APPLICATIONS

This application claims priority from Japanese patent application number 2011-218411, filed on Sep. 30, 2011, the disclosure of which is hereby incorporated by reference.

### BACKGROUND OF THE INVENTION

1. Field of the Invention

This invention relates to a mutually advertising system in which business enterprises mutually provide advertisements (ads) to each other. In addition, this invention relates to advertisement (ad) distribution planning apparatus and method, and a related computer program.

2. Description of the Related Art

In recent years, digital signages have been spread. Usually, digital signages are provided in stores, streets, and transportation facilities.

A typical digital signage includes a display or a projector indicating digital contents related to ads (advertisements). Generally, digital contents are moving pictures. The typical digital signage is advantageous over a conventional still signboard in that the contents of indicated ads can easily be changed and viewers tend to be more interested in indicated ads.

Digital signages can use relatively small displays or projectors. Thus, digital signages are frequently placed in retail stores or small stores.

It is conceivable to build a mutually advertising system designed so that business enterprises having respective digital signages distant from each other can mutually provide ads to each other. In an example of operation of such a conceivable system, one business enterprise provides its ads to at least one other business enterprise and allows the provided ads to be indicated by a digital signage of the other business enterprise.

In a conceivable mutually advertising system, the available advertising effect depends on which of other business enterprises the ads of one business enterprise are distributed to, and to what degree the ads are distributed.

The rate of distributing ads is restricted since the transmission lines between business enterprises have limited data transfer capacities, and time intervals during which digital signages can be occupied are limited. It is desirable to select business enterprises, to which ads should be distributed, so as to enhance the advertising effect as greatly as possible.

### SUMMARY OF THE INVENTION

It is a first object of this invention to provide a mutually advertising system which can effectively distribute advertisements (ads).

It is a second object of this invention to provide an advertisement (ad) distribution planning apparatus which enables effective distribution of ads.

It is a third object of this invention to provide an ad distribution planning method which enables effective distribution of ads.

It is a fourth object of this invention to provide a computer program which enables effective distribution of ads.

An aspect of this invention provides a mutually advertising system comprising an ad distribution planning apparatus; and a plurality of ad indication systems connected with the ad distribution planning apparatus via a network. Each of the ad indication systems comprises a digital signage for indicating ads distributed from the ad distribution planning apparatus, and a viewing index calculating section for calculating viewing indexes with respect to the respective ads indicated by the digital signage and for sending the calculated viewing indexes to the ad distribution planning apparatus. The ad distribution planning apparatus comprises a relation degree calculating section for, with respect to each of the ad indication systems, identifying advertisers corresponding to the respective ads among business enterprises, for calculating evaluation values of the viewing indexes sent from the ad indication systems and regarding each of the identified advertisers, and for calculating degrees of relations between the business enterprises from the calculated evaluation values. The ad distribution planning apparatus further comprises an ad allotting section for setting distribution allotment degrees for each of ads to be distributed to the ad indication systems in accordance with the relations degrees calculated by the relation degree calculating section.

Other aspects of this invention provide an advertisement distribution planning apparatus, an ad distribution planning method, and a computer program which enable effective distribution of ads.

This invention has the following advantage. In a mutually advertising system designed so that business enterprises mutually provide ads to each other, it is possible to implement effective distribution of the ads.

### BRIEF DESCRIPTION OF THE DRAWINGS

FIG. 1 is a block diagram of a mutually advertising system according to an embodiment of this invention.

FIG. 2 is a block diagram of an ad (advertisement) distribution planning apparatus in FIG. 1.

FIG. 3 is a diagram showing an example of the structure of a business enterprise information table in FIG. 2.

FIG. 4 is a diagram showing an example of the structure of an ad information table in FIG. 2.

FIG. 5 is a diagram showing an example of the structure of a distribution information table in FIG. 2.

FIG. 6 is a diagram showing an example of the structure of a viewing degree information table in FIG. 2.

FIG. 7 is a block diagram of an ad indication/viewing evaluation system in FIG. 1.

FIG. 8 is a diagram showing an example of the structure of a viewing-information storing table in FIG. 7.

FIG. 9 is a flowchart of operation of the ad indication/viewing evaluation system in FIG. 7.

FIG. 10(a) is a diagram showing an example of the IDs of played-back ads and the mean viewer numbers for the respective ad IDs.

FIG. 10(b) is a diagram showing an example of the IDs of played-back ads, the mean viewer numbers and the viewing degrees for the respective ad IDs.

FIG. 11 is a flowchart of plan making operation of the ad distribution planning apparatus in FIG. 2.

FIG. 12 is a diagram showing an example of mean viewing degrees assigned to respective pairs each of the ID of an ad-playback business enterprise and the ID of an advertiser business enterprise.

FIG. 13(a) is a diagram showing an example of the degrees of relations between business enterprises.

FIG. 13(b) is a diagram showing an example of distribution allotment ratios defined between advertiser business enterprises and distribution-destination business enterprises.

### DETAILED DESCRIPTION OF THE INVENTION

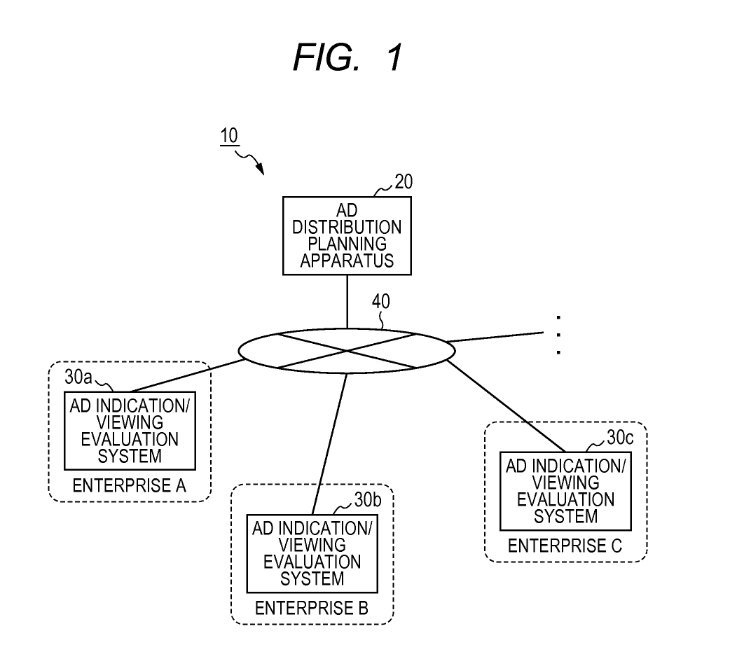

With reference to FIG. 1, a mutually advertising system 10 in an embodiment of this invention includes an ad (advertisement) distribution planning apparatus 20, and ad indication/viewing evaluation systems 30 (30a, 30b, 30c, . . . ) which are interconnected by a communication network 40.

Each of the ad indication/viewing evaluation systems 30a, 30b, 30c, . . . contains at least one digital signage and serves as an ad indication system. The digital signage is used to indicate an ad or ads (advertisements). Different IDs are assigned to the ads, respectively. Furthermore, each of the ad indication/viewing evaluation systems 30a, 30b, 30c, . . . serves as a viewing evaluation system for evaluating conditions in which the ad or ads indicated by the digital signage are viewed. The ad indication/viewing evaluation systems 30a, 30b, 30c, . . . are placed in, for example, stores of business enterprises “A”, “B”, “C”, . . . , respectively. Different IDs are assigned to the business enterprises “A”, “B”, “C”, . . . , respectively.

The ad distribution planning apparatus 20 serves to distribute ads of the business enterprises “A”, “B”, “C”, . . . among the ad indication/viewing evaluation systems 30a, 30b, 30c, . . . of the business enterprises “A”, “B”, “C”, . . . . An administrator of the ad distribution planning apparatus 20 collects ad charges (ad rates) from the business enterprises “A”, “B”, “C”, . . . , and administrates the ad distribution planning apparatus 20 by using the collected ad charges. The ad distribution planning apparatus 20 determines the amounts of the ads distributed to the ad indication/viewing evaluation systems 30a, 30b, 30c, . . . on the basis of the ad charges paid by the business enterprises “A”, “B”, “C”, . . . , respectively. Regarding the distribution of the ads, the ad distribution planning apparatus 20 makes an ad distribution plan or scheme designed to enhance the advertising effect.

To each of the ad indication/viewing evaluation systems 30a, 30b, 30c, . . . , ads of the business enterprises except one having the present ad indication/viewing evaluation system are distributed via the ad distribution planning apparatus 20. For example, to the ad indication/viewing evaluation system 30a of the business enterprise “A”, ads of the business enterprises “B”, “C”, . . . are distributed. The digital signage in each of the ad indication/viewing evaluation systems 30a, 30b, 30c, . . . indicates and play backs ads of the corresponding business enterprise during normal ranges of time, and indicates and plays back ads of the other business enterprise (that is, ads distributed via the ad distribution planning apparatus 20) during given ranges of time between the normal ranges. It should be noted that ads of each of the business enterprises “A”, “B”, “C”, . . . may be distributed to its own ad indication/viewing evaluation system also via the ad distribution planning apparatus 20.

In the mutually advertising system 10, each of the business enterprises “A”, “B”, “C”, . . . functions as an ad distribution destination in which a digital signage in a store plays back distributed ads of the other business enterprises. Furthermore, each of the business enterprises “A”, “B”, “C”, . . . functions as an advertiser being a provider for ads played back by the digital signages of the other business enterprises.

Preferably, the ad distribution planning apparatus 20 is formed by an information processing apparatus such as a server computer or a personal computer. The information processing apparatus includes a combination of a CPU, memories, a hard disk device, input/output interfaces, a communication device, and other devices. The information processing apparatus operates in accordance with a computer program stored in one of the memories and the hard disk device.

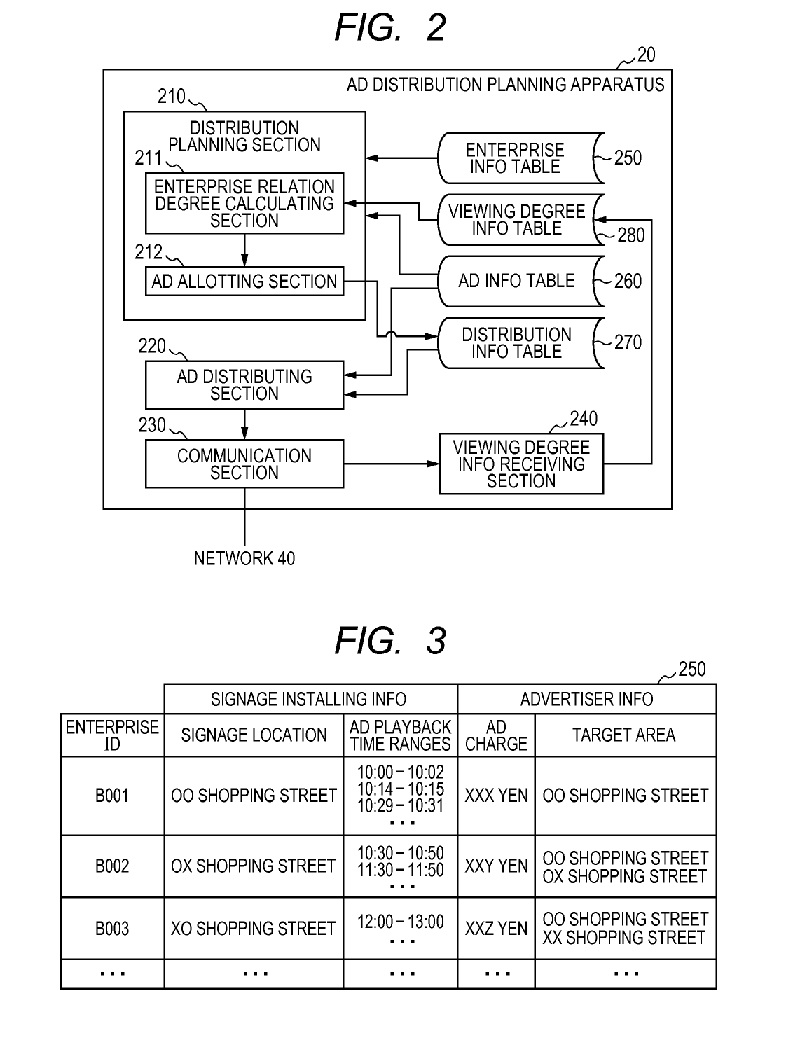

With reference to FIG. 2, the ad distribution planning apparatus 20 includes a distribution planning section 210, an ad distributing section 220, a communication section 230, a viewing-degree-information receiving section 240, a business enterprise information table 250, an ad information table 260, a distribution information table 270, and a viewing degree information table 280. Preferably, the computer program for the information processing apparatus is designed to enable the ad distribution planning apparatus 20 to implement the sections 210, 220, and 240. Generally, the communication section 230 is formed by the input/output interfaces. Each of the tables 250-280 is provided in one of the memories or the hard disk device.

The distribution planning section 210 makes a plan or scheme for distribution of ads to the business enterprises “A”, “B”, “C”, . . . , and stores the made scheme in the distribution information table 270. To implement this operation, the distribution planning section 210 includes a business-enterprise relation-degree calculating section 211 and an ad allotting section 212.

The business-enterprise relation-degree calculating section 211 calculates the degrees of relations among the business enterprises “A”, “B”, “C”, . . . by referring to the ad information table 260 and the viewing degree information table 280. The business-enterprise relation-degree calculating section 211 feeds the calculated relation degrees to the ad allotting section 212. Specifically, the degree of a relation between two business enterprises is a value resulting from evaluating the degree to which viewers are interested in ads of the two business enterprises.

In more detail, a first viewing index is introduced as an indication of how many people viewed ads of a first business enterprise through a digital signage of a second business enterprise different from the first business enterprise. A second viewing index is introduced as an indication of how many people viewed ads of the second business enterprise through a digital signage of the first business enterprise. The degree of a relation between the first and second business enterprises is a value resulting from evaluating the first and second viewing indexes.

A higher degree of a relation between two business enterprises means more customers and passers-by viewing ads of the two business enterprises. In the case of two business enterprises in a high-degree relation, it is thought that the two business enterprises are similar in quality of customers and surrounding environments, and that customers of the two business enterprises are substantially interested in common objects. Accordingly, it can be expected that the advertising effect will be increased by mutually distributing ads between two business enterprises in a high-degree relation.

The ad allotting section 212 allots ads of the business enterprises “A”, “B”, “C”, . . . to distribution destinations on the basis of the relation degrees calculated by the business-enterprise relation-degree calculating section 211. The ad allotting section 212 stores the result of the allotment in the distribution information table 270. The ad allotting section 212 carries out the allotment by referring to the business enterprise information table 250 and the ad information table 260. The allotment by the ad allotting section 212 is designed so that greater amounts of ads will be distributed between ad indication/viewing evaluation systems in business enterprises in higher-degree relations, and thereby the advertising effect will be higher.

The ad distributing section 220 implements a process of distributing ads to the ad indication/viewing evaluation systems 30a, 30b, 30c, . . . in the business enterprises “A”, “B”, “C”, . . . while referring to the ad information table 260 and the distribution information table 270.

The communication section 230 communicates with the ad indication/viewing evaluation systems 30a, 30b, 30c, . . . in the business enterprises “A”, “B”, “C”, . . . through the communication network 40.

The viewing-degree-information receiving section 240 receives viewing degree information pieces from the ad indication/viewing evaluation systems 30a, 30b, 30c, . . . in the business enterprises “A”, “B”, “C”, . . . respectively through the communication section 230. The viewing-degree-information receiving section 240 adds, to the received viewing degree information pieces, the IDs of the corresponding business enterprises “A”, “B”, “C”, . . . respectively before storing the ID-added viewing degree information pieces in the viewing degree information table 280. Preferably, a viewing degree is an index denoting the degree to which a distributed ad was viewed in the ad indication/viewing evaluation system 30 of the corresponding business enterprise. Specifically, a viewing degree results from normalizing the number of viewers regarding each of distributed ads, and takes “1” for the maximum number of viewers.

The business enterprise information table 250 stores information having pieces relating to the business enterprises “A”, “B”, “C”, . . . respectively. FIG. 3 shows an example of the structure of the business enterprise information table 250 in which signage installing information and advertiser information are stored for each of the IDs (B001, B002, B003, . . . ) of the business enterprises “A”, “B”, “C”, . . . . The signage installing information relates to a side indicating ads while the advertiser information relates to a side providing ads.

The ad indication/viewing evaluation systems 30a, 30b, 30c, . . . are in a one-to-one correspondence with the business enterprises “A”, “B”, “C”, . . . respectively. Thus, the ad indication/viewing evaluation systems 30a, 30b, 30c, . . . can be identified by using the business enterprise IDs (B001, B002, B003, . . . ) in the business enterprise information table 250.

As shown in FIG. 3, for each of the IDs (B001, B002, B003, . . . ) of the business enterprises “A”, “B”, “C”, . . . , the signage installing information has a first segment indicating the location of the related digital signage, and a second segment indicating a list of time ranges during which a distributed ad or ads are played back by the related digital signage. These time ranges are called ad playback time ranges.

The location of a digital signage is, for example, a name of a shopping street where the digital signage is located. The location of a digital signage may be an address, an administrative district, or another. The location of a digital signage is called a digital-signage location.

For example, the digital signage of the business enterprise “A” identified by an ID of B001 plays back an ad or ads of the business enterprise “A” for normal time ranges, and plays back an ad or ads of one or more other business enterprises, which are distributed via the ad distribution planning apparatus 20, for given time ranges (ad playback time ranges) different from the normal time ranges. For example, the ad playback time ranges are expressed as 10:10-10:02, 10:14-10:15, 10:29-10:31, . . . . There may be a set of ad playback time ranges for a weekday and another set for Saturday, Sunday, and a holiday. The ad playback time ranges may be in selected one or ones of the days of the week only.

Each of the business enterprises “A”, “B”, “C”, . . . notifies the ad playback time ranges concerning the corresponding digital signage to the administrator of the ad distribution planning apparatus 20. As the sum of the lengths of the ad playback time ranges concerning a digital signage of a business enterprise is greater, an ad or ads of one or more other business enterprises are played back by the digital signage for a longer time. Thus, for a business enterprise having a greater sum of the lengths of ad playback time ranges concerning a corresponding digital signage, an ad charge demanded may be discounted or larger amounts of ads of the business enterprise may be distributed to other business enterprises.

As shown in FIG. 3, for each of the IDs (B001, B002, B003, . . . ) of the business enterprises “A”, “B”, “C”, . . . , the advertiser information has a first segment indicating an ad charge to be paid, and a second segment indicating an area or areas to which an ad or ads should be provided. The area or areas are called a target area or areas. The ad charge contains a system use fee to be paid to the administrator of the ad distribution planning apparatus 20, and fees to be paid to other business enterprises for distribution of the ad or ads thereto. The amount of the distributed ad or ads, the number of times of the ad distribution, and the distributed range of the ad or ads are decided depending on the ad charge. In the case where a charge discount is done depending on ad playback time range, the ad charge occurring before the charge discount is stored in the business enterprise information table 250. The number of times of the ad playback, the ad playback time, or the playback time length may be stored instead of the ad charge.

In FIG. 3, the target area or areas for each of the IDs (B001, B002, B003, . . . ) of the business enterprises “A”, “B”, “C”, . . . are places to which the ad or ads should be provided or distributed. The ad or ads are actually distributed to a digital signage or signages in the target area or areas. The target area or areas are designed to be in a correspondence with the digital-signage location or locations. The target area or areas can be set by a request from the related business enterprise.

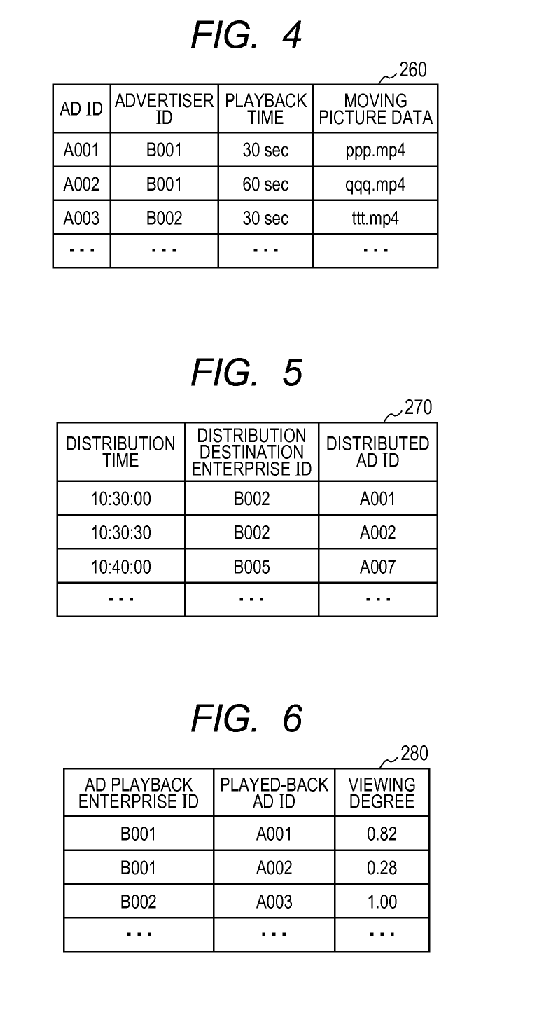

The ad information table 260 stores information about an ad or ads provided by the business enterprises “A”, “B”, “C”, . . . . FIG. 4 shows an example of the structure of the ad information table 260 in which, for each of the IDs of ads, the stored information has a first segment indicating the ID of a business enterprise being an advertiser providing the present ad, a second segment indicating a playback time (playback time length) for the present ad, and a third segment occupied by moving picture data representative of the present ad. The advertiser business-enterprise ID is the ID of a business enterprise providing the ad as an advertiser. The playback time means a duration (time interval) for which the ad should be played back. The moving picture data represents the ad to be played back by a digital signage or signages. It should be noted that one business enterprise may provide ads. The distribution information table 270 stores information indicating a schedule of the distribution of ads to the business enterprises “A”, “B”, “C”, . . . FIG. 5 shows an example of the structure of the distribution information table 270 in which the stored information represents sets each of distribution time, the ID of a business enterprise being a distribution destination, and the ID of an ad to be distributed. As shown in FIG. 5, the sets are arranged in the order of distribution time. The sets may not be sorted or may be arranged in one of other orders. The ad distributing section 220 refers to each of the sets in the distribution information table 270, and thereby identifies an ad and a business enterprise in accordance with the ad ID and the distribution-destination business-enterprise ID in the set and distributes the identified ad to the ad indication/viewing evaluation system 30 of the identified business enterprise at a moment equal to the distribution time in the set. Preferably, the distributed ad contains not only moving pictures but also the ID thereof.

The viewing degree information table 280 stores information about viewing degrees of respective ads which were played back by the digital signages of the business enterprises “A”, “B”, “C”, . . . . FIG. 6 shows an example of the structure of the viewing degree information table 280 in which the stored information represents sets each of the ID of a business enterprise possessing a digital signage which played back an ad, the ID of the played-back ad, and a viewing degree regarding the played-back ad. In FIG. 6, a viewing degree for an ad having an ID of A001 that was played back by the digital signage of a business enterprise having an ID of B001 is equal to 0.82. A viewing degree for an ad having an ID of A002 that was played back by the digital signage of the business enterprise having an ID of B001 is equal to 0.28. A viewing degree for an ad having an ID of A003 that was played back by the digital signage of a business enterprise having an ID of B002 is equal to 1.00.

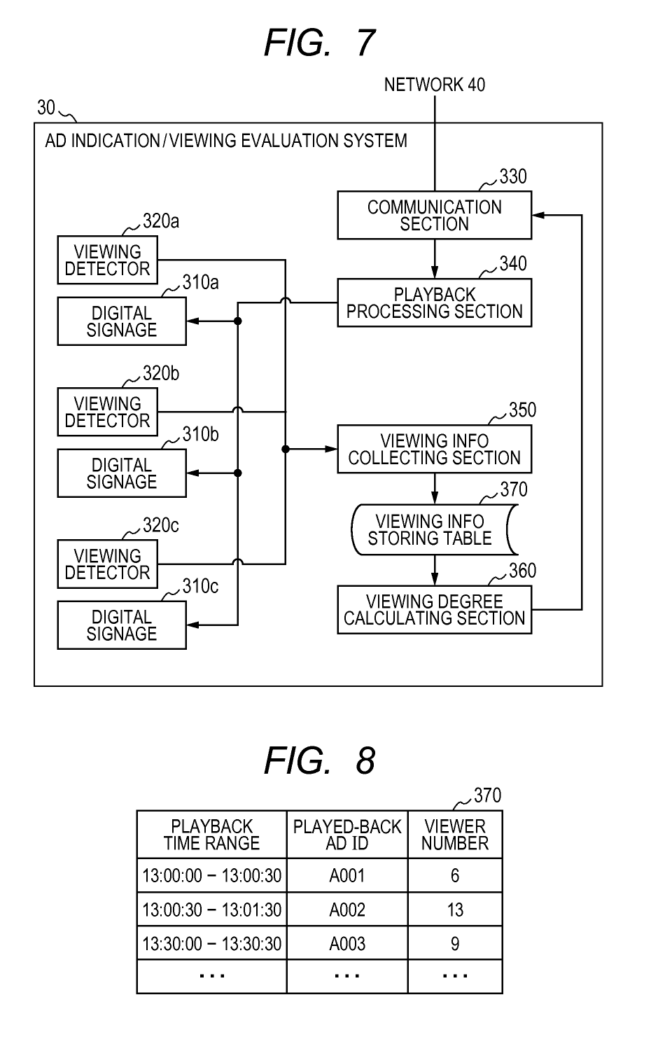

With reference to FIG. 7, the ad indication/viewing evaluation system 30 includes digital signages 310 (310a, 310b, and 310c), viewing detectors 320 (320a, 320b, and 320c), a communication section 330, a playback processing section 340, a viewing-information collecting section 350, a viewing-degree calculating section 360, and a viewing-information storing table 370. The digital signage 310a and the viewing detector 320a make a pair. The digital signage 310b and the viewing detector 320b make a pair. The digital signage 310c and the viewing detector 320c make a pair. It should be noted that the ad indication/viewing evaluation system 30 may have only one digital signage 310.

Each digital signage 310 includes a display or a projector, and indicates digital contents such as an ad on the display or the projector. Preferably, the digital signages 310 in the ad indication/viewing evaluation system 30 simultaneously play back a same ad.

Each viewing detector 320 measures the number of people viewing the ad played back by the associated digital signage 310. The viewing detector 320 may be a known detector such as a detector disclosed in Japanese patent application publication number 2008-112401. Preferably, the viewing detector 320 includes a camera for taking a picture of a view area about the associated digital signage 310, a first section for recognizing, from the taken picture, every person in the view area who is viewing an ad played back by the associated digital signage 310, and a second section for counting the persons recognized by the first section.

The view detector 320 may use one of other ways of measuring the number of people viewing a played-back ad. According to a first example, a device for distributing related information or coupons by using NFC (Near Field Communication) is provided adjacently to each digital signage, and communications between the device and portable devices held by viewers are detected to measure the numbers of the viewers. In this case, it is thought that each viewer performs NFC receiving operation with respect to the held portable device while having an interest in a played-back ad, and hence the number of viewers interested in the ad can be accurately measured. According to a second example, sensors detect every person entering a viewing area and every person leaving the viewing area, and the number of people viewing a played-back ad is measured on the basis of the detections by the sensors. According to a third example, a warden measures the number of viewers through visual observation, and inputs the measured number into a machine.

The communication section 330 performs a process for communications with the ad distribution planning apparatus 20 via the communication network 40.

The playback processing section 340 receives, via the communication section 330, data (digital data) representing an ad distributed from the ad distribution planning apparatus 20. The playback processing section 340 subjects the received data to signal processing for ad playback to generate processing-resultant data, and feeds the processing-resultant data to the digital signages 310a, 310b, and 310c. The playback processing section 340 controls the digital signages 310a, 310b, and 310c to indicate the ad represented by the processing-resultant data.

Preferably, the playback processing section 340 extracts the ID of the ad from the received data. The playback processing section 340 notifies the extracted ID of the ad to the viewing-information collecting section 350. Preferably, the playback processing section 340 notifies the playback time range for the ad to the viewing-information collecting section 350.

The viewing-information collecting section 350 receives, from the viewing detectors 320a, 320b, and 320c, signals representing the measured numbers of people viewing a played-back ad. The viewing-information collecting section 350 calculates a mean or an average of the numbers of people viewing a played-back ad, and labels the calculated mean or average as the number of viewers. For every played-back ad, the viewing-information collecting section 350 is notified of the playback time range for the ad and the ID of the ad. The viewing-information collecting section 350 stores the number of viewers in the viewing-information storing table 370 while adding the playback time range and the played-back ad ID thereto. In the case where the ad indication/viewing evaluation system 30 has two digital signages 310 only, the viewing-information collecting section 350 calculates the sum of the numbers of people viewing an ad played back by the digital signages 310, and divides the calculated sum by 2 to obtain the number of viewers. In the case where an ad is played back for each of different time ranges, the numbers of people viewing the ad played back by the digital signages 310a, 310b, and 310c are averaged to obtain the number of viewers for each of the time ranges.

FIG. 8 shows an example of the structure of the viewing-information storing table 370. As shown in FIG. 8, information stored in the viewing-information storing table 370 represents sets each of a playback time range, the ID of a played-back ad, and the number of viewers of the ad. The table 370 in FIG. 8 shows that the number of viewers is equal to 6 for an ad having an ID of A001 which was played back during a time range from 13:00:00 to 13:00:30.

With reference back to FIG. 7, the viewing-degree calculating section 360 refers to the viewing-information storing table 370, and thereby sums the numbers of viewers for each ad ID which are detected during a prescribed summation term to calculate a viewing degree for each ad ID. The calculated viewing degrees for the respective ad IDs result from normalizing the sums of the viewer numbers so that the maximum of the calculated viewing degrees will be equal to 1. Thus, among ads played back during the prescribed summation term, an ad greatest in summed viewer number is given a viewing degree of 1.

The viewing degree for each ad ID may be calculated in another way. For example, the viewing degree for each ad ID is equalized to the ratio of the sum of the viewer numbers for the ad ID to the total viewer number with respect to the business enterprise having the ad indication/viewing evaluation system 30.

The viewing-degree calculating section 360 notifies the communication section 330 of the ad IDs and the calculated viewing degrees for the respective ad IDs. The communication section 330 sends the ad IDs and the viewing degrees to the ad distribution planning apparatus 20 via the communication network 40. Preferably, the communication section 330 adds, to the ad IDs and the viewing degrees, the ID of the related business enterprise as a sender ID.

The ad indication/viewing evaluation system 30 may include a computer system having a combination of a CPU, a ROM, a RAM, and an input/output port. The computer system operates in accordance with a computer program in the ROM or the RAM. The computer program may be designed to enable the computer system to serve as at least one of the communication section 330, the playback processing section 340, the viewing-information collecting section 350, the viewing-degree calculating section 360, and the viewing-information storing table 370.

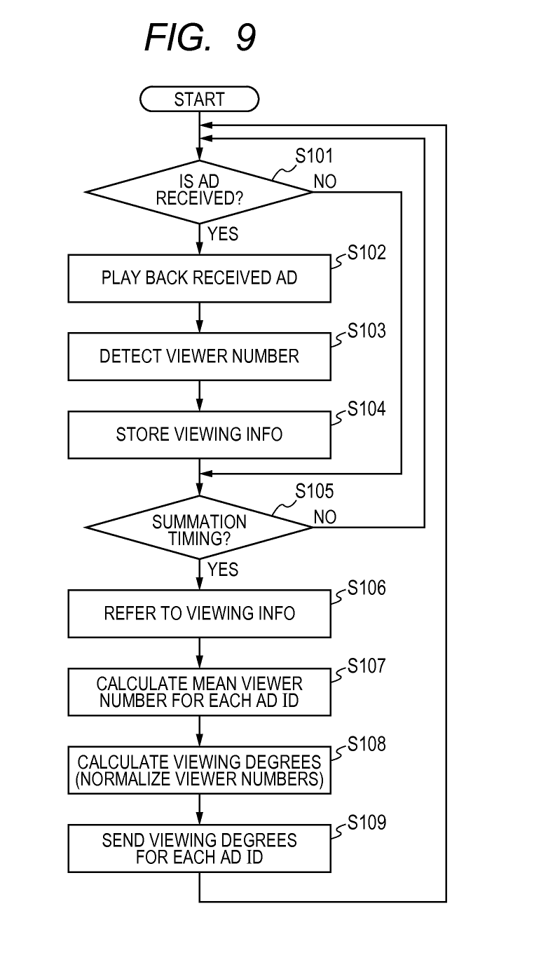

FIG. 9 is a flowchart of operation of the ad indication/viewing evaluation system 30 which may be implemented by the computer program for the computer system therein. Preferably, the ad distribution planning apparatus 20 distributes an ad or ads on a real-time basis. In this case, an ad to be played back by the business enterprise “A” at 10:00:00 is distributed to the business enterprise “A” from the ad distribution planning apparatus 20 at 10:00:00. A time lag may be considered for the distribution of the ad. Each ad may be distributed in advance while the time for which the ad should be played back is designated.

With reference to FIG. 9, the first step S101 in the operation decides whether or not an ad distributed from the ad distribution planning apparatus 20 is received by the communication section 330. When an ad is received, the operation advances from the step S101 to a step S102. Otherwise, the operation jumps from the step S101 to a step S105.

The step S102 subjects data (digital data) representative of the received ad to signal processing for ad playback to generate processing-resultant data, and feeds the processing-resultant data to the digital signage or signages 310. The step S102 controls the digital signage or signages 310 to indicate the ad represented by the processing-resultant data.

A step S103 following the step S102 refers to the signals from the viewing detectors 320, and calculates the number of viewers regarding the played-back ad on the basis of the people numbers represented by the signals from the viewing detectors 320. A step S104 subsequent to the step S103 detects the time range for which the ad is played back, and the ID of the ad. Preferably, the ad ID is extracted from the received ad. The step S104 stores the calculated number of viewers in the viewing-information storing table 370 while adding the playback time range for the ad and the ID of the ad thereto. After the step S104, the operation advances to the step S105.

The sequence of the steps S102, S103, and S104 is done each time an ad is distributed from the ad distribution planning apparatus 20.

The step S105 decides whether or not the present time reaches a prescribed summation timing. When the present time reaches the prescribed summation timing, the operation advances from the step S105 to a step S106. Otherwise, the operation returns from the step S105 to the step S101.

The step S106 refers to the viewing-information storing table 370, and reads out therefrom the numbers of viewers for different ad IDs. A step S107 following the step S106 calculates a mean or an average of the numbers of viewers concerning the playback of each ad ID during different time ranges. Thereby, the step S107 calculates the mean viewer number (average viewer number) for each ad ID.

A step S108 subsequent to the step S107 normalizes the mean viewer numbers for the respective ad IDs so that the maximum of the normalized mean viewer numbers will be equal to 1. The step S108 labels the normalized viewer numbers as viewing degrees for the respective ad IDs. A step S109 following the step S108 controls the communication section 330 to send a set of the ad IDs and the viewing degrees for the respective ad IDs to the ad distribution planning apparatus 20 via the communication network 40. Preferably, the communication section 330 is controlled to add, to the set, the ID of the related business enterprise as a sender ID. After the step S109, the operation returns to the step S101.

Accordingly, when the ad indication/viewing evaluation system 30 receives an ad distributed from the ad distribution planning apparatus 20 (the step S101), the playback processing section 340 subjects data representative of the received ad to signal processing for ad playback to generate processing-resultant data, and feeds the processing-resultant data to the digital signage or signages 310. The playback processing section 340 controls the digital signage or signages 310 to indicate and play back the ad represented by the processing-resultant data (the step S102).

The ad-playback signal processing by the playback processing section 340 includes, for example, converting the data representative of the received ad into a format suited for indication by the digital signage or signages 310. In the case where an ad is distributed in advance while the time during which the ad should be played back is designated, the ad-playback signal processing by the playback processing section 340 may further include feeding data representative of the ad to the digital signage or signages 310 at the designated playback time.

During the playback of an ad, the viewing detectors 320 measure the numbers of people viewing the ad indicated by the respective digital signages 310 (the step S103). When the playback of the ad is terminated, the viewing-information collecting section 350 obtains the numbers of people viewing the played-back ad from the viewing detectors 320. The viewing-information collecting section 350 averages the obtained people numbers to calculate the number of viewers for the ad. The playback processing section 340 detects the time range for which the ad is played back, and the ID of the ad. Preferably, the ad ID is extracted from the received ad. The playback processing section 340 notifies the viewing-information collecting section 350 of the detected playback time range and the detected ad ID. The viewing-information collecting section 350 stores the calculated number of viewers in the viewing-information storing table 370 while adding the playback time range for the ad and the ID of the ad thereto (the step S104).

When the present time reaches a prescribed summation timing (the step S105), the ad indication/viewing evaluation system 30 performs the following process of making viewing degrees. Preferably, the prescribed summation timing is per day or week. The prescribed summation timing is common to all the ad indication/viewing evaluation systems 30a, 30b, 30c, . . . in the business enterprises “A”, “B”, “C”, . . . .

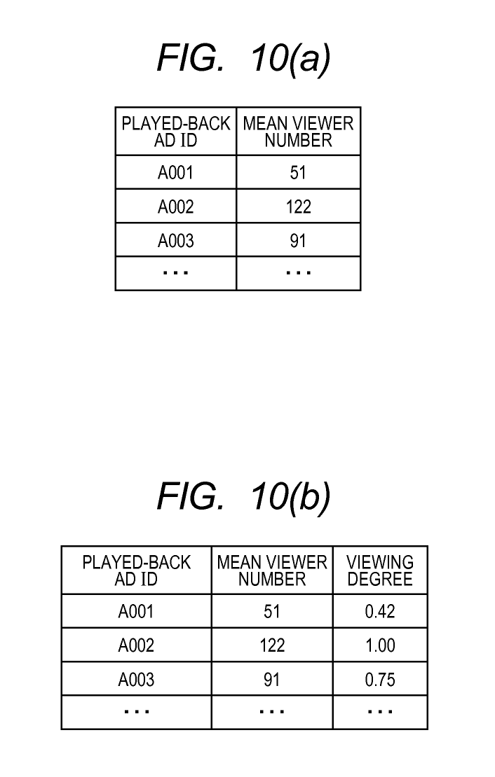

In the viewing-degree making process, the ad indication/viewing evaluation system 30 refers to the viewing-information storing table 370 (the step S106), and reads out therefrom the numbers of viewers for different ad IDs. The ad indication/viewing evaluation system 30 calculates a mean or an average of the numbers of viewers concerning the playback of each ad ID during different time ranges (the step S107). Thereby, the ad indication/viewing evaluation system 30 calculates the mean viewer number (average viewer number) for each ad ID. An example of the calculated mean viewer numbers for the respective ad IDs is shown in FIG. 10(a).

In the viewing-degree making process, the ad indication/viewing evaluation system 30 normalizes the mean viewer numbers for the respective ad IDs so that the maximum of the normalized mean viewer numbers will be equal to 1. The ad indication/viewing evaluation system 30 labels the normalized viewer numbers as viewing degrees for the respective ad IDs (the step S108). An example of the mean viewer numbers and the viewing degrees for the respective ad IDs is shown in FIG. 10(b). In the example of FIG. 10(b), an ad having an ID of A002 is the greatest in viewer number so that the viewing degree for the ad ID being A002 is equal to 1. The ad indication/viewing evaluation system 30 controls the communication section 330 to send a set of the viewing degrees for the respective ad IDs to the ad distribution planning apparatus 20 via the communication network 40 (the step S109). Preferably, the communication section 330 adds, to the set, the ID of the related business enterprise as a sender ID. Then, the viewing-degree making process is terminated.

The ad distribution planning apparatus 20 receives a set of ad IDs and viewing degrees for the respective ad IDs from each of the ad indication/viewing evaluation systems 30a, 30b, 30c, . . . in the business enterprises “A”, “B”, “C”, . . . via the communication network 40. In the ad distribution planning apparatus 20, the received set of the ad IDs and the viewing degrees for the respective ad IDs is transferred to the viewing-degree-information receiving section 240 from the communication section 230. The viewing-degree-information receiving section 240 refers to the business enterprise information table 250 or the distribution information table 270, and thereby detects the ID of a source business enterprise (an ad-playback business enterprise or a distribution-destination business enterprise) sending the set of the ad IDs and the viewing degrees for the respective ad IDs. Preferably, the viewing-degree-information receiving section 240 extracts a sender ID from the received set, and collates the extracted sender ID with the business enterprise information table 250 or the distribution information table 270 to identify the source business enterprise. The viewing-degree-information receiving section 240 stores the received ad IDs and the received viewing degrees for the respective ad IDs in the viewing degree information table 280 (FIG. 6) while adding the ID of the identified business enterprise (the ad-playback business enterprise) thereto.

The calculation of viewing degrees may be carried out by the ad distribution planning apparatus 20. In this case, each time the viewing-information collecting section 350 in the ad indication/viewing evaluation system 30 in each of the business enterprises “A”, “B”, “C”, . . . averages obtained people numbers to calculate the number of viewers for a played-back ad, the ad indication/viewing evaluation system 30 ads the ID of the played-back ad to the calculated number of viewers and sends the result of the addition to the ad distribution planning apparatus 20. On the other hand, the ad distribution planning apparatus 20 is modified to include sections and a table equivalent to the viewing-information collecting section 350, the viewing-degree calculating section 360, and the viewing-information storing table 370 in the ad indication/viewing evaluation system 30 respectively. When the present time reaches a prescribed summation timing, the ad distribution planning apparatus 20 carries out a process corresponding to the sequence of the steps S106-S109 in FIG. 9.

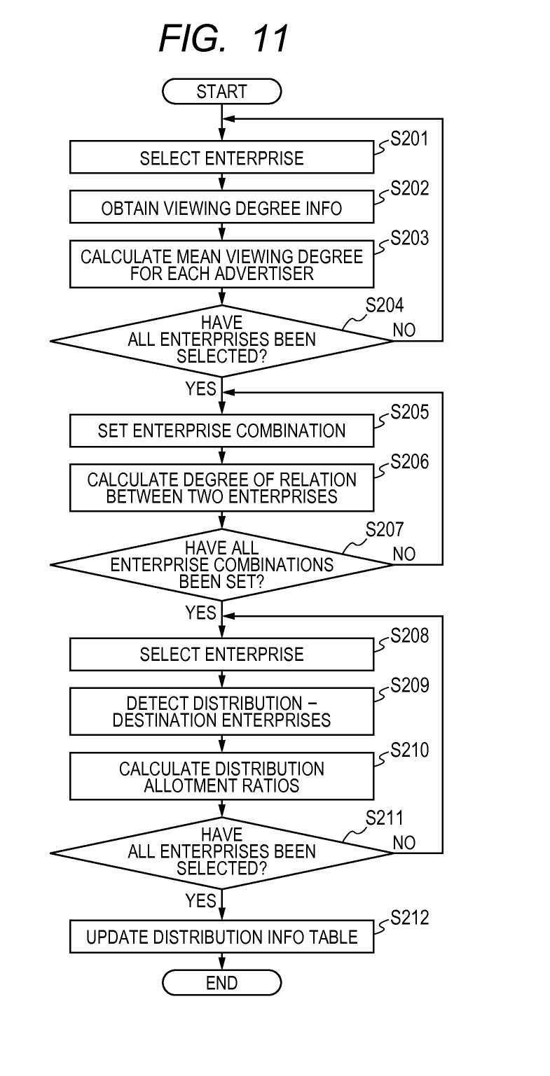

A description will be given below of operation of the ad distribution planning apparatus 20 for making an ad distribution plan or scheme. The ad distribution planning apparatus 20 operates in accordance with the computer program stored therein. FIG. 11 is a flowchart of the plan making operation of the ad distribution planning apparatus 20 which is implemented by a segment of the computer program. Preferably, the plan making operation is started when sets of viewing degrees have been received from all the ad indication/viewing evaluation systems 30 in the business enterprises “A”, “B”, “C”, . . . . Thus, the distribution information table 270 denoting an ad distribution plan or scheme is updated at every moment equal to the prescribed summation timing for the ad indication/viewing evaluation systems 30.

With reference to FIG. 11, the first step S201 of the plan making operation selects one from the business enterprises “A”, “B”, “C”, . . . . The step S201 is designed to sequentially select the business enterprises “A”, “B”, “C”, . . . as it is iterated. A step S202 following the step S201 obtains viewing degree information about the selected business enterprise from the viewing degree information table 280. A step S203 subsequent to the step S202 refers to the ad information table 260 and thereby calculates a mean viewing degree (an average viewing degree) for each of advertisers with respect to the selected business enterprise. A step S204 following the step 5203 decides whether or not all the business enterprises “A”, “B”, “C”, . . . have been selected by the step S201. When all the business enterprises “A”, “B”, “C”, . . . have been selected, the operation advances from the step S204 to a step S205. Otherwise, the operation returns from the step S204 to the step S201.

The step S205 sets a combination of two of the business enterprises “A”, “B”, “C”, . . . as a target. A step S206 following the step S205 calculates the degree of the relation between the two business enterprises. Specifically, the step S206 labels the two business enterprises as the first and second business enterprises respectively. The step S206 retrieves a first mean viewing degree for an advertiser with respect to an ad-playback business enterprise in the case where the first and second business enterprises serve as the advertiser and the ad-playback business enterprise respectively. The step S206 retrieves a second mean viewing degree for an advertiser with respect to an ad-playback business enterprise in the case where the first and second business enterprises serve as the ad-playback business enterprise and the advertiser respectively. The step S206 calculates a mean or an average of the first and second mean viewing degrees, and labels the calculated mean (average) as the degree of the relation between the two enterprises. A step S207 subsequent to the step S206 decides whether or not all the possible combinations of twos of the business enterprises “A”, “B”, “C”, . . . have been set as the targets. When all the possible combinations of twos of the business enterprises “A”, “B”, “C”, . . . have been set as the targets, the operation advances from the step

S207 to a step S208. Otherwise, the operation returns from the step S207 to the step S205. Accordingly, the step S205 is designed to sequentially set the possible combinations of twos of the business enterprises “A”, “B”, “C”, . . . as the targets while it is iterated.

The step S208 selects one from the business enterprises “A”, “B”, “C”, . . . . The step S208 is designed to sequentially select the business enterprises “A”, “B”, “C”, . . . as it is iterated. A step S209 following the step S208 obtains the target area or areas for the selected business enterprise from the business enterprise information table 250. The step S209 detects a distribution-destination business enterprise or enterprises possessing a digital signage or signages 310 located in the target area or areas. For the distribution-destination business enterprise or each of the distribution-destination business enterprises, a step S210 subsequent to the step S209 retrieves the degree of the relation between the selected business enterprise and the distribution-destination business enterprise. The step S210 calculates a distribution allotment ratio for each distribution-destination business enterprise from the retrieved degree of the relation between the selected business enterprise and the distribution-destination business enterprise. Preferably, the calculated distribution allotment ratio for each distribution-destination business enterprise increases as the degree of the relation between the selected business enterprise and the distribution-destination business enterprise increases. The calculated distribution allotment ratio may be proportional to the relation degree. A step S211 following the step S210 decides whether or not all the business enterprises “A”, “B”, “C”, . . . have been selected by the step S208. When all the business enterprises “A”, “B”, “C”, . . . have been selected, the operation advances from the step S211 to a step 5212. Otherwise, the operation returns from the step S211 to the step S208.

The step S212 implements ad allotment for each of advertiser business enterprises by referring to the calculated distribution allotment ratios, the ad playback time ranges in the business enterprise information table 250, and the ad information table 260. The step S212 updates the distribution information table 270 in accordance with the implemented ad allotment. After the step S212, the plan making operation ends.

In the plan making operation, the business-enterprise relation-degree calculating section 211 in the distribution planning section 210 calculates a mean viewing degree for each advertiser with respect to each of the business enterprises “A”, “B”, “C”, . . . (the steps S201-S204). Thereafter, the business-enterprise relation-degree calculating section 211 calculates the degrees of relation between twos of the business enterprises “A”, “B”, “C”, . . . (the steps S205-S207). Then, the ad allotting section 212 in the distribution planning section 210 calculates a distribution allotment ratio for each of the business enterprises “A”, “B”, “C”, . . . (the steps S208-S211). The ad allotting section 212 implements actual ad allotment on the basis of the calculated distribution allotment ratios. Finally, the ad allotting section 212 updates the distribution information table 270 in accordance with the implemented ad allotment (the step S212).

Specifically, the business-enterprise relation-degree calculating section 211 selects one from the business enterprises “A”, “B”, “C”, . . . (the step S201). The business-enterprise relation-degree calculating section 211 obtains viewing degree information about the selected business enterprise from the viewing degree information table 280 (the step S202). The business-enterprise relation-degree calculating section 211 refers to the ad information table 260 and thereby calculates a mean viewing degree for each of advertisers with respect to the selected business enterprise (the step S203).

In the case where the viewing degree information table 280 stores viewing degrees for ads “a”-“z” played back by the business enterprise “A” being the selected business enterprise, the business-enterprise relation-degree calculating section 211 identifies advertiser business enterprises for the ads “a”-“z” by referring to the ad information table 260. For each of the identified advertiser business enterprises, the business-enterprise relation-degree calculating section 211 calculates a mean of the viewing degrees and labels the calculated mean as a mean viewing degree. For example, when an advertiser for the ad “a”-“d” is the business enterprise “D”, a mean of the viewing degrees for the ad “a”-“d” is labeled as a mean viewing degree for the advertiser business enterprise “D”.

The above-mentioned actions by the business-enterprise relation-degree calculating section 211 are iterated while the selected business enterprise is repetitively changed from one to another (the steps S204 and S201). Thus, the above-mentioned actions are implemented with respect to all the business enterprises “A”, “B”, “C”, . . . . Accordingly, the mean viewing degree for each advertiser with respect to each of the business enterprises “A”, “B”, “C”, . . . can be used as a viewing degree evaluation value being an viewing index.

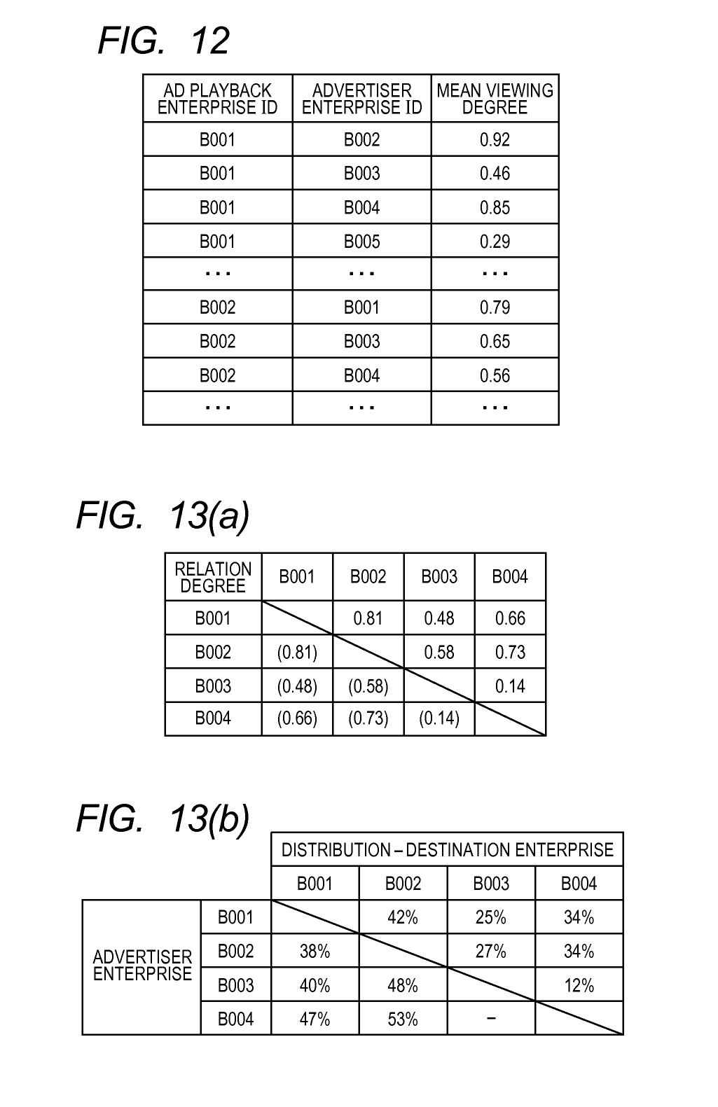

FIG. 12 shows an example of mean viewing degrees for advertiser business enterprises with respect to ad-playback business enterprises. With reference to FIG. 12, a mean viewing degree is equal to 0.92 for an ad of a business enterprise having an ID of B002 which was played back by a digital signage 310 possessed by a business enterprise having an ID of B001. In addition, a mean viewing degree is equal to 0.46 for an ad of a business enterprise having an ID of B003 which was played back by the digital signage 310 of the business enterprise “B001”. Furthermore, a mean viewing degree is equal to 0.85 for an ad of a business enterprise having an ID of B004 which was played back by the digital signage 310 of the business enterprise “B001”. In addition, a mean viewing degree is equal to 0.29 for an ad of a business enterprise having an ID of B005 which was played back by the digital signage 310 of the business enterprise “B001”. Thus, it is understood that people who view the digital signage 310 of the business enterprise “B001” are greatly interested in the ad of the business enterprise “B002”.

The business-enterprise relation-degree calculating section 211 sets a combination of two of the business enterprises “A”, “B”, “C”, . . . as a target (the step S205). Then, the business-enterprise relation-degree calculating section 211 calculates the degree of the relation between the two business enterprises. Specifically, the business-enterprise relation-degree calculating section 211 labels the two business enterprises as the first and second business enterprises respectively. The business-enterprise relation-degree calculating section 211 retrieves a first mean viewing degree for an advertiser with respect to an ad-playback business enterprise in the case where the first and second business enterprises serve as the advertiser and the ad-playback business enterprise respectively. The business-enterprise relation-degree calculating section 211 retrieves a second mean viewing degree for an advertiser with respect to an ad-playback business enterprise in the case where the first and second business enterprises serve as the ad-playback business enterprise and the advertiser respectively. The business-enterprise relation-degree calculating section 211 calculates a mean of the first and second mean viewing degrees, and labels the calculated mean as the degree of the relation between the two enterprises.

Thus, a high degree of the relation between the business enterprises “A” and “B” means that many people view an ad of the business enterprise “B” which is played back by the digital signage or signages 310 of the business enterprise “A”, and that many people view an ad of the business enterprise “A” which is played back by the digital signage or signages 310 of the business enterprise “B”. Accordingly, it is thought that two business enterprises in a high-degree relation are similar in quality of customers and surrounding environments, and that customers of the two business enterprises are substantially interested in common objects.

The above-mentioned actions by the business-enterprise relation-degree calculating section 211 are iterated while the target combination of two business enterprises is repetitively changed from one to another (the steps S207 and S205). Thus, the above-mentioned actions are implemented with respect to all the possible combinations of twos of the business enterprises “A”, “B”, “C”, . . . . The degree of the relation of the business enterprise “A” with the business enterprise “B” is equal to that of the relation of the business enterprise “B” with the business enterprise “A”. Thus, it is good to calculate only one of the degree of the relation of the business enterprise “A” with the business enterprise “B” and the degree of the relation of the business enterprise “B” with the business enterprise “A”. Accordingly, the mean viewing degree for each advertiser with respect to each of the business enterprises “A”, “B”, “C”, . . . can be used as a viewing degree evaluation value being an viewing index.

FIG. 13(a) shows an example of the degrees of relation between twos of the business enterprises “A”, “B”, “C”, . . . . In FIG. 13(a), degrees of relation of an business enterprise having an ID of B001 with business enterprises having IDs of B002, B003, and B004 are equal to 0.81, 0.48, and 0.66 respectively. It is understood that the degree of the relation of the business enterprise “B001” with the business enterprise “B002” is relatively high. In FIG. 13(a), the degree of the relation of the business enterprise “B002” with the business enterprise “B001” is expressed as (0.81) meaning that the calculation of this relation degree is unnecessary since this relation degree is equal to the degree of the relation of the business enterprise “B001” with the business enterprise “B002”.

The ad allotting section 212 selects one from the business enterprises “A”, “B”, “C”, . . . (the step S208). The ad allotting section 212 obtains the target area or areas for the selected business enterprise from the business enterprise information table 250. The ad allotting section 212 detects a distribution-destination business enterprise or enterprises possessing a digital signage or signages 310 located in the target area or areas (the step S209). For example, in the case where the selected business enterprise is the business enterprise “A” and a target area “P” is for the business enterprise “A”, a business enterprise or enterprises having a digital signage or signages 310 in the target area “P” are a distribution-destination business enterprise or enterprises. Thereafter, for the distribution-destination business enterprise or each of the distribution-destination business enterprises, the ad allotting section 212 retrieves the degree of the relation between the selected business enterprise and the distribution-destination business enterprise. The ad allotting section 212 calculates a distribution allotment ratio for each distribution-destination business enterprise from the retrieved degree of the relation between the selected business enterprise and the distribution-destination business enterprise (the step S210). Preferably, the calculated distribution allotment ratio for each distribution-destination business enterprise increases as the degree of the relation between the selected business enterprise and the distribution-destination business enterprise increases. The calculated distribution allotment ratio may be proportional to the relation degree.

The above-mentioned actions by the ad allotting section 212 are iterated while the selected business enterprise is repetitively changed from one to another (the steps S211 and S208). Thus, the above-mentioned actions are implemented with respect to all the business enterprises “A”, “B”, “C”, . . . .

FIG. 13(b) shows an example of the distribution allotment ratios depending on the degrees of relation between twos of the business enterprises “A”, “B”, “C”, . . . . With reference to FIG. 13(b), in the case where degrees of relation of an business enterprise having an ID of B001 with business enterprises having IDs of B002, B003, and B004 are equal to 0.81, 0.48, and 0.66 respectively (FIG. 13(a)), corresponding distribution allotment ratios are equal to 42%, 25%, and 34% respectively. The sum of the distribution allotment ratios is substantially equal to 100%. Thus, in this case, an ad of the business enterprise “B001” is allotted and distributed to the business enterprises “B002”, “B003”, and “B004” at distribution allotment ratios of 42%, 25%, and 34% respectively.

For example, in the case where the business enterprise “B001” has paid an ad charge for 100-times playback of an ad, the business enterprise “B001” distributes the ad to the business enterprise “B002” 42 times and distributes the ad to the business enterprise “B003” 25 times, and distributes the ad to the business enterprise “B004” 34 times. Thereby, it is possible to attain a high advertising effect.

In FIG. 13(b), the cell for indicating a distribution allotment ratio for the advertiser business enterprise “B004” with respect to the ad-playback business enterprise “B003” is blank. The blank cell shows that the business enterprise “B003” is not a distribution-destination business enterprise with respect to the business enterprise “B004”. In FIG. 13(b), distribution allotment ratios for the advertiser business enterprise “B004” with respect to the ad-playback business enterprises “B001” and “B002” are equal to 47% and 53% respectively. The sum of the distribution allotment ratios is equal to 100%.

It is sufficient that distribution allotment ratios depend on corresponding relation degrees. Distribution allotment ratios may be calculated from corresponding relation degrees in one of prescribed ways. A distribution allotment ratio with respect to an ad-playback business enterprise corresponding to a high relation degree may be especially great. A distribution allotment ratio with respect to an ad-playback business enterprise corresponding to a low relation degree may be equal to 0%.

Finally, the ad allotting section 212 implements actual ad allotment for each of advertiser business enterprises by referring to the calculated distribution allotment ratios, the ad playback time ranges in the business enterprise information table 250, and the ad information table 260. The ad allotting section 212 updates the distribution information table 270 in accordance with the implemented ad allotment (the step S212).

It is sufficient that actual ad allotments depend on distribution allotment ratios. Actual ad allotments may be implemented in response to distribution allotment ratios in one of prescribed ways. According to an example of carrying out actual ad allotments, a business enterprise is set as a target and an add thereof is scheduled to be played back by the digital signage or signages in a distribution-destination business enterprise a preset number of times during ad playback time ranges for which the digital signage or signages are unoccupied. These actions are iterated while the target business enterprise is changed from one to another and the distribution-destination business enterprise is changed from one to another also.

The mutually advertising system 10 has the following advantage. An advertiser business enterprise distributes a greater amount of ad to a distribution-destination business enterprise having a higher relation with the advertiser business enterprise. Accordingly, it is possible to effectively distribute ads.

What is claimed is:

1. A mutually advertising system comprising:
an ad distribution planning apparatus; and
a plurality of ad indication systems connected with the ad distribution planning apparatus via a network;
wherein each of the ad indication systems comprises a digital signage for indicating ads distributed from the ad distribution planning apparatus, and a viewing index calculating section for calculating viewing indexes with respect to the respective ads indicated by the digital signage and for sending the calculated viewing indexes to the ad distribution planning apparatus;
wherein the ad distribution planning apparatus comprises a relation degree calculating section for, with respect to each of the ad indication systems, identifying advertisers corresponding to the respective ads among business enterprises, for calculating evaluation values of the viewing indexes sent from the ad indication systems and regarding each of the identified advertisers, and for calculating degrees of relations between the business enterprises from the calculated evaluation values; and
wherein the ad distribution planning apparatus further comprises an ad allotting section for setting distribution allotment degrees for each of ads to be distributed to the ad indication systems in accordance with the relations degrees calculated by the relation degree calculating section.

2. A mutually advertising system as recited in claim 1, wherein the viewing index calculating section in each of the ad indication systems comprises a viewing detector for detecting the numbers of viewers of the respective ads indicated by the digital signage, and means for normalizing the detected viewer numbers with a maximum viewer number in a prescribed term to obtain the viewing indexes.

3. An ad distribution planning apparatus connected with a plurality of ad indication systems via a network, the apparatus comprising:
a receiving section for receiving, from the ad indication systems, viewing indexes about ads indicated by the ad indication systems;
a relation degree calculating section for, with respect to each of the ad indication systems, identifying advertisers corresponding to the respective ads among business enterprises, for calculating evaluation values of the received viewing indexes regarding each of the identified advertisers, and for calculating degrees of relations between the business enterprises from the calculated evaluation values; and
an ad allotting section for setting distribution allotment degrees for each of ads to be distributed to the ad indication systems in accordance with the relations degrees calculated by the relation degree calculating section.

4. An ad distribution planning apparatus connected with a plurality of ad indication systems via a network, the apparatus comprising:
a receiving section for receiving, from the ad indication systems, viewing indexes about ads indicated by the ad indication systems;
a relation degree calculating section for, with respect to each of the ad indication systems, identifying advertisers corresponding to the respective ads among business enterprises, for calculating evaluation values equal to averages of the received viewing indexes regarding each of the identified advertisers, and for calculating degrees of relations between the business enterprises from the calculated evaluation values; and
an ad allotting section for setting distribution allotment degrees for each of ads to be distributed to the ad indication systems in accordance with the relations degrees calculated by the relation degree calculating section.

5. An ad distribution planning apparatus as recited in claim 3, wherein the degree of the relation between first and second ones of the business enterprises which is calculated by the relation degree calculating section is equal to a mean of a value of evaluation of the first one of the business enterprises by the second one of the business enterprise and a value of evaluation of the second one of the business enterprise by the first one of the business enterprises.

6. An ad distribution planning apparatus as recited in claim 4, wherein the degree of the relation between first and second ones of the business enterprises which is calculated by the relation degree calculating section is equal to a mean of a value of evaluation of the first one of the business enterprises by the second one of the business enterprise and a value of evaluation of the second one of the business enterprise by the first one of the business enterprises.

7. A method of planning the distribution of ads, comprising the steps of:
receiving, from ad indication systems, viewing indexes about ads indicated by the ad indication systems;
with respect to each of the ad indication systems, identifying advertisers corresponding to the respective ads among business enterprises;
calculating evaluation values of the received viewing indexes regarding each of the identified advertisers;
calculating degrees of relations between the business enterprises from the calculated evaluation values; and
setting distribution allotment degrees for each of ads to be distributed to the ad indication systems in accordance with the calculated relations degrees.

8. A computer program for enabling an information processing apparatus to function as:
a receiving section for receiving, from ad indication systems, viewing indexes about ads indicated by the ad indication systems;
a relation degree calculating section for, with respect to each of the ad indication systems, identifying advertisers corresponding to the respective ads among business enterprises, for calculating evaluation values of the received viewing indexes regarding each of the identified advertisers, and for calculating degrees of relations between the business enterprises from the calculated evaluation values; and
an ad allotting section for setting distribution allotment degrees for each of ads to be distributed to the ad indication systems in accordance with the relations degrees calculated by the relation degree calculating section.
